(19) United States
(12) Patent Application Publication
(10) Pub. No.: US 2006/0169956 A1
(43) Pub. Date: Aug. 3, 2006

(54) Tightening device for cables and similar

(76) Inventor: Ulrich Bitterolf, Kempten (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/471,143

(22) PCT Filed: Mar. 5, 2002
(86) PCT No.: PCT/EP02/02399

§ 371 Date: Mar. 29, 2004

(30) Foreign Application Priority Data
Mar. 5, 2001 (DE) 201 03 810.2

(51) Int. Cl. B25B 25/00

(52) U.S. Cl. 254/217

(57) ABSTRACT

The aim of the invention is to produce a tightening device for cables or similar for controlling the transmission of force. Said device comprises a clamping disk (6) and a deflector (10) engaging therebetween. As a result, the cable (4) is guided between the deflector (10) and a guiding element (20) arranged on the periphery of the clamping disk (6).

A tightening device for cables and the like have always played an important role in easing the workload for humanity. Cable winches and pulley blocks should be mentioned in particular.

Cable winches wind up a cable and are of large design and have a high weight depending on the cable length to be wound up. Although pulley blocks do not wind up cables, they also have a high weight through several deflection rollers and are of large design. In many areas where cables are currently used there is a desire for a tightening apparatus with minute dimensions and compact size (e.g. in the construction industry, sports climbing, emergency services, shipping, windsurfing and sailing sports).

A tightening apparatus is known from DE 2500731 A1 for ropes, cables or wires, wherein a clamping disk with mutually opposite conical surfaces is described into which a deflector projects. The clamping disk can be driven by means of a crank and can be provided with profilings for the purpose of increasing the frictional resistance. The tightening apparatus is to be especially suitable as a winch for sailing yachts in order to allow a rapid tightening of a rope or cable. A controlled loosening of the cable (e.g. a rewind) is not possible in this case because the cable would detach from the clamping disk.

The invention is therefore based on the object of providing a tightening apparatus for cables and the like which allows a controlled transmission of force and a small, compact design.

This object is achieved by the features as mentioned in claim 1. Further advantageous embodiments of the invention are stated in the dependent claims.

The invention ensures that cables are tightened and relieved in a defined manner as in cable winches. However, the cable is not wound up. The cable is merely threaded into the clamping disk and tightens the cable via the clamping disk until the cable is tightened. Once the tensile force becomes too high, a drive of the clamping disk is used, e.g. a lever apparatus. Depending on the lever length it is possible to transmit forces which far exceed the weight of the exerting person, For example, a climber hanging from the cable can lever himself upwardly all by himself.

As a result of the guiding element which is provided in accordance with the invention which is substantially opposite to the deflector on the circumference of the clamping disk, a secure wrap is ensured even during the reverse motion of the cable, so that the loose end of the cable or the like is guided into the clamping disk. As a result, a tightening and relaxing is possible in both rotational directions of the tightening apparatus, e.g. for the tightening of a windsurfing sail which when necessary can be slightly slackened for the purpose of adjustment to the respective wind conditions for example and can later be tightened again for adjustment to the wind conditions. The cable, rope or rope end is held securely in the clamping disk by the guiding element. The guiding element can be fixedly arranged on the circumference of the clamping disk, e.g. in the form of a spring steel tongue aligned in the direction towards the center of the clamping disk. The guiding element can also be provided with a movable arrangement, especially swivelable on a lever. In order to adapt as precisely as possible to the course of the loose end of the cable the guiding element is arranged as a roller which can also contribute to the reduction of the wear and tear on the cable. For this purpose the guiding element can also engage on the circumference of the clamping disk between the wedge surfaces and act upon the loose end of the cable. The guiding element can also be provided with a tubular or loop-like shape. In the possible application on the base of a mast of a windsurfing sail the guiding element can also be arranged within the base of the mast, thus leading to an especially compact design.

The scope of application can be extended by using different drives for the clamping disk. Depending on the respective application, the drive of the clamping disk can be provided by a ratchet mechanism, a crank or other electric or mechanical drive. A preferably provided ribbing or profiling of the clamping disk leads to the advantage that the cable is grasped tightly during the tightening and allows an easy rolling off of the cable end. The security of the transmission of force is thus increased. Moreover, the cable is treated with care and its life is increased.

An embodiment is now explained by reference to the enclosed drawings, wherein:

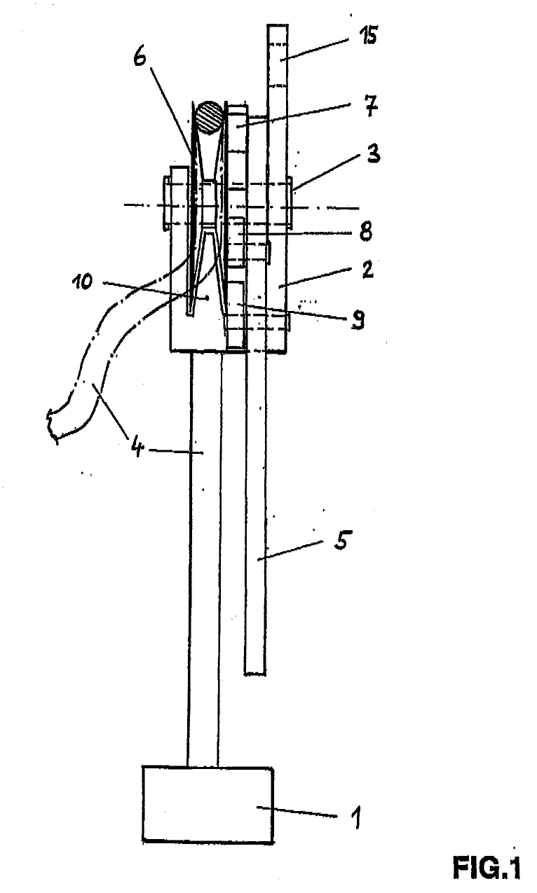

FIG. 1 shows a tightening apparatus with load;

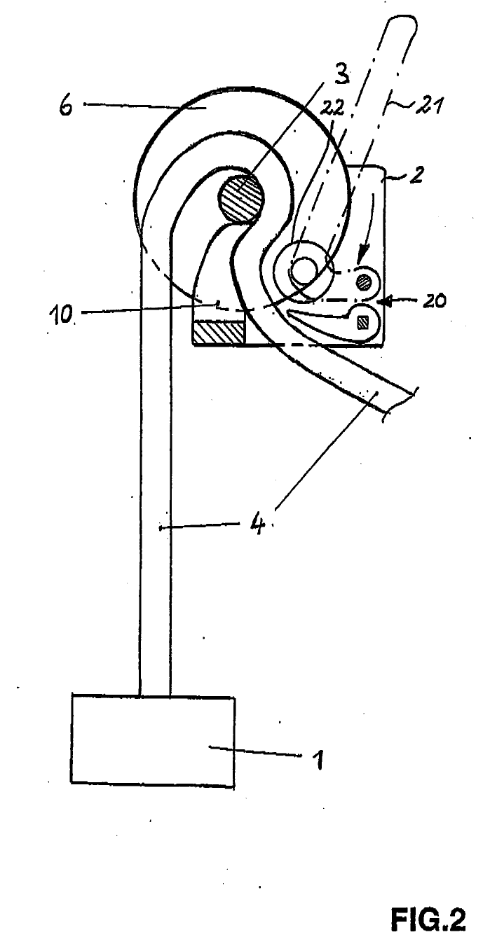

FIG. 2 shows a partial side view in the plane of the clamping disk which illustrates the course of the cable, and

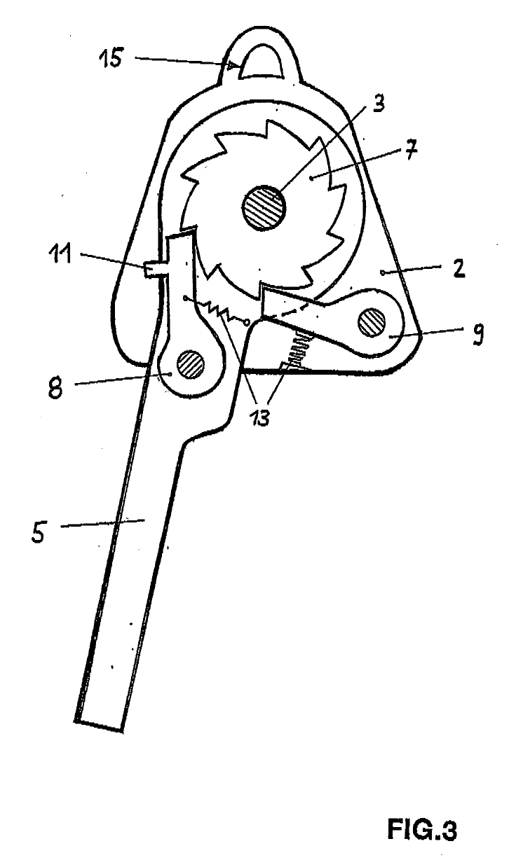

FIG. 3 shows a partial side view in the plane of the ratchet drive which explains the lever mechanism.

FIG. 1 shows an example of a tightening apparatus. The tightening apparatus is fastened to a holding device 2 with an eye 15, e.g. to a climbing harness. The eye 15 is preferably arranged in the same vertical plane as the course of the cable in order to avoid any moments of tilt. For this purpose the holding device 2 is bent in the region of eye 15 relative to the clamping disk 6. The cable 4 is fastened to a load 1 and is guided on a clamping disk 6. In this way the load 1 is fixed to the holding device 2. The holding device 2 comprises a shaft 3. In addition to the clamping disk 6, a ratchet toothed disk 7 and a lever 5 are mounted on the shaft 3 (cf. FIG. 3). A ratchet element 8 is fixed on a lever 5 and a latching element 9 is held on the holding device 2.

FIG. 2 clearly shows the course of the cable. The load 1 is fastened to the cable 4. The cable 4 is guided on the clamping disk 6. The cable 4 is wedged by the tensile force at the loose end on the clamping disk 6. The cable 4 is wound up by rotation of the clamping disk 6. After approx. 300° the deflector 10 unwedges the cable 4. The cable 4 is thus rolled off and becomes loose. The wedging surfaces on the clamping disk 6 are configured in such a way that the cable 4 will clamp securely depending on the coefficient of friction and allows unwinding without damaging the cable.

The relevant aspect is the arrangement of a guiding element 20 on the circumference of the clamping disk 6, so that the guiding element 20 is substantially opposite to the deflector 10. The guiding element 20 can be arranged fixedly, especially in the manner of a tongue as is indicated in the lower region of the holding device 2. The guiding element 20 can also be arranged movably on a lever 21. In this way the guiding element 20 can thus even engage between the wedge surfaces of the clamping disk 6 and conform especially precisely to the course of the cable. Preferably, the lever 21 carries a roller 22 in the corner region, which roller rests on the loose end of the cable 4. In this way it is possible to achieve a precise pressing on and clinging to the course of the cable. The guiding element 20 which is shown here in two alternatives (fixed and swivelably movable) can also be provided with a pipe-like or tubular arrangement. In this case the loose end of the cable 4 would extend in said guiding element 20. The guiding element 20 lies substantially opposite of the deflector 10, so that the loose end of the cable 4 is guided precisely between said components 10 and 20. As indicated above, the term “cable” shall also relate to wires, ropes and the like, especially to rope ends used in sailing sports.

FIG. 3 shows a type of a drive for the clamping disk 6, which in this case is lever mechanism. The said clamping disk 6 is fixedly connected with the ratchet toothed wheel 7. The clamping disk 6 is blocked in the left direction (counter-clockwise) by the ratchet element 9 with a spring 13 and can only be moved in the right direction (clockwise). The transmission of force of the lever 5 onto the ratchet toothed wheel 7 occurs via the ratchet element 8 which is also pressed by a spring. In the right direction the transmission of force occurs for tightening, whereas in the left direction the cable 4 can be loosened or relaxed in a defined manner in order to be brought optionally into the initial position again with the lever 5 for the purpose of renewed tightening.

The relevant aspect is that a defined tightening and relaxing of the cable 4 is possible in stages, as is desirable by the respective user. As a result of the guiding element as proposed herein it is securely prevented that the cable 4 can detach in an uncontrolled way from the clamping disk 6. Rather, the wrap is definitely ensured because during the reverse motion of the cable the loose end is guided by the guiding element 20 into the clamping disk 6. As a result of the movable configuration of the guiding element 20, especially on a lever and/or in the form of a roller, a cling or pressing to the course of the cable is achieved, so that the wear and tear of the cable and the frictional losses during the drive are reduced.

What is claimed is:

1. A tightening apparatus for cables, comprising a clamping disk and a deflector engaging there between, characterized in that the cable is guided between the deflector and guiding element arranged on the circumference of the clamping disk, wherein the tightening apparatus is arranged at the base of a mast of a windsurfing sail, and wherein the guiding element is provided with a pipe-like or tubular configuration in which the loose part of the cable is guided.

2. A tightening apparatus as claimed in claim 1, characterized in that the guiding element is arranged in a fixed way, especially in the form of a spring steel tongue.

3. A tightening apparatus as claimed in claim 1, characterized in that the guiding element is arranged in a movable way.

4. A tightening apparatus as claimed in claim 3, characterized in that the guiding element is arranged in a swivelable way on a lever.

5. A tightening apparatus as claimed in claim 1, characterized in that the guiding element is arranged as a roller.

6. A tightening apparatus as claimed in claim 1, characterized in that the guiding element engages between wedge surfaces of the clamping disk and acts on the loose part of the cable.

7. (canceled)

8. A tightening apparatus as claimed in claim 1, characterized in that a ratchet lever, a crank or an electric drive is provided for driving the clamping disk.

9. A tightening apparatus as claimed in claim 1, characterized in that the clamping disk is provided on its wedge surfaces with a profiling.

10. (canceled)
